(19) United States
(12) Patent Application Publication
(10) Pub. No.: US 2017/0240379 A1
(43) Pub. Date: Aug. 24, 2017

(54) COMMUNICATION OF EXPECTED ELEVATOR BOARDING TIME

(71) Applicant: OTIS ELEVATOR COMPANY, Farmington, CT (US)

(72) Inventors: Paul A. Simcik, Southington, CT (US); Peter DePaola, South Windsor, CT (US); Bradley Armand Scoville, Farmington, CT (US)

(21) Appl. No.: 15/437,497

(22) Filed: Feb. 21, 2017

Related U.S. Application Data
(60) Provisional application No. 62/299,218, filed on Feb. 24, 2016.

(51) Int. Cl. B66B 1/24; B66B 1/46; B66B 13/14

(52) U.S. Cl. CPC B66B 1/2408; B66B 13/14; B66B 1/468; B66B 1/2458; B66B 2201/4653; B66B 2201/103; B66B 2201/4615; B66B 2201/214

(57) ABSTRACT

An elevator system configured to determine and transmit an estimated elevator boarding time to a mobile call input device, wherein the boarding time includes the arrival time of the elevator car based on a registered target floor registration information and the duration of time to place the elevator car door and the hoistway door in a fully open state.

### CROSS-REFERENCE TO RELATED APPLICATIONS

The present application is a nonprovisional patent application, which claims priority to U.S. Patent Application Ser. No. 62/299,218, filed Feb. 24, 2016, which is herein incorporated in its entirety.

### TECHNICAL FIELD OF THE DISCLOSED EMBODIMENTS

The present disclosure generally relates to elevator systems, and more particularly, the present disclosure relates to communication of expected elevator boarding time.

### BACKGROUND OF THE DISCLOSED EMBODIMENTS

Entering an elevator call from a location away from the elevator provides convenience to a user to allow an elevator car to be potentially ready once the user arrives at the elevator doors. Current mobile devices allow for requesting elevator travel services. The user of a mobile device may be located at a distance further away from the elevator doors than compared to using traditional hall buttons or destination entry devices that are located near the elevator entrances. In such instances, it would be beneficial to display information on the time when the user may board the elevator.

### SUMMARY OF THE DISCLOSED EMBODIMENTS

In one aspect, an elevator system is provided. The elevator system includes an elevator hoistway, wherein the elevator hoistway includes a hoistway door, an elevator car disposed within the elevator hoistway, the elevator car including an elevator car door, and a door operating device operably coupled to the elevator car door, wherein the door operating device is configured to move the elevator car door and the hoistway door between a fully open state and a fully closed state.

The elevator system further includes an elevator controller operably coupled to the elevator car, wherein the elevator controller is configured to receive registered target floor registration information, assign the elevator car based in part on a registered target floor registration information, compute an estimated boarding time based in part on an existing condition of the assigned elevator car, and transmit the estimated boarding time; wherein the estimated boarding time comprises the arrival time of the elevator car based on the registered target floor registration information and the duration of time to place the elevator car door and the hoistway door in a fully open state. In any embodiment, the elevator system further includes a plurality of communication modules in communication with the elevator controller. In an embodiment, the elevator controller is further configured to transmit an elevator arrival signal. In an embodiment, the elevator arrival signal includes a time wherein the assigned elevator car is located at the registered target floor and the elevator car door and the hoistway door are in a fully open state.

In any embodiment, the elevator system further includes a mobile call input device in communication with the elevator controller, wherein the mobile call input device includes a registration operation part to create the registered target floor registration information.

In an embodiment, the mobile call input device further comprises a display. In any embodiment, the mobile call input device is configured to allow a user to create the registered target floor registration information by registering a target floor using a graphical object displayed thereon, receive the estimated boarding time from the elevator controller, and display the estimated boarding time. In any embodiment, the mobile call input device is in wireless communication with the elevator controller. In any embodiment, the mobile call input device includes a mobile telephone.

In one aspect, a method of determining an estimated elevator boarding time is provided. The method uses an elevator system in communication with a mobile call input device, the elevator system includes an elevator car disposed within an elevator hoistway including a hoistway door, the elevator car including an elevator car door and a door operating device operably coupled to the elevator car door, wherein the door operating device is configured to move the elevator car door and hoistway door between a fully open state and a fully closed state, and an elevator controller operably coupled to the elevator car.

The method includes operating the mobile call input device to generate registered target floor registration information, operating the elevator controller to receive the registered target floor registration information, and assign an elevator car based in part on a registered target floor registration information, operating the elevator controller to compute an estimated boarding time based in part on the existing condition of the assigned elevator car, and operating the elevator controller to transmit the estimated boarding time to the mobile call input device; wherein the estimated boarding time comprises the arrival time of the elevator car based on the registered target floor registration information and a duration of time to place the elevator car door and the hoistway door in a fully open state.

In an embodiment, the method further includes operating the elevator controller to transmit an elevator arrival signal. In an embodiment, the elevator arrival signal includes a time wherein the assigned elevator car is located at the registered target floor and the elevator car door and the hoistway door are in a fully open state

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an elevator system according to an embodiment of the present disclosure;

FIG. 2 is a schematic diagram of a mobile call input device according to an embodiment of the present disclosure; and

FIGS. 3A-3C is a schematic diagram of a mobile call input device displaying an estimated elevator boarding time according to embodiments of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

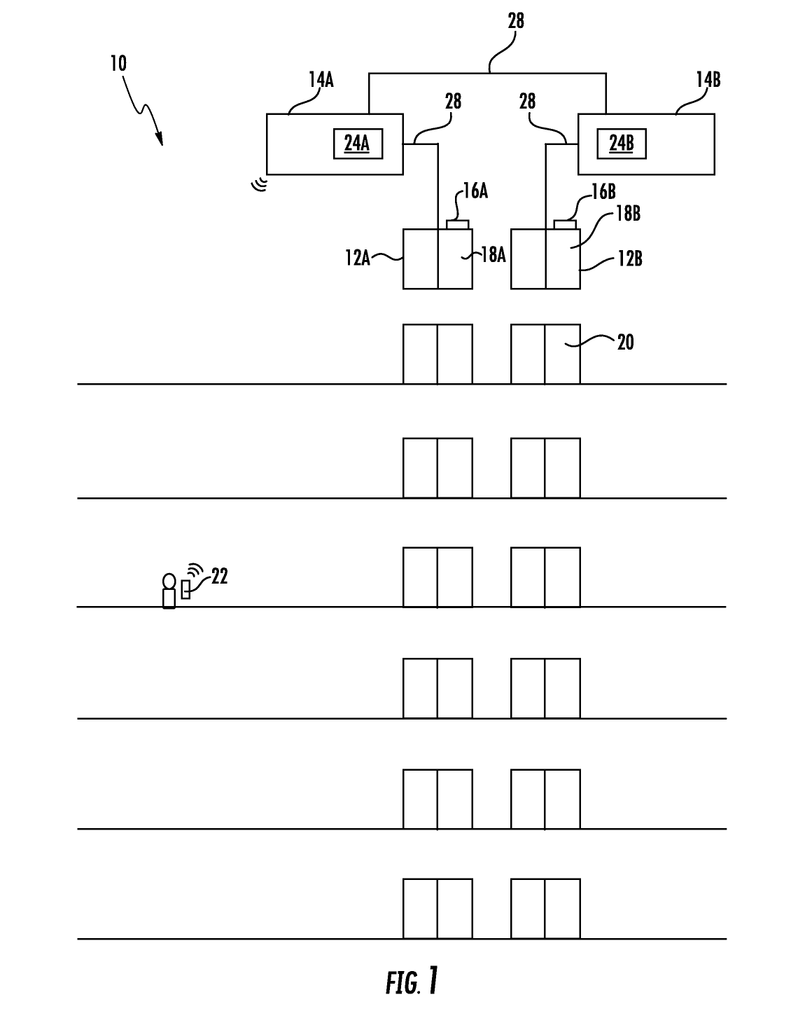

FIG. 1 shows an embodiment of an elevator system, generally indicated at 10. The elevator system 10 includes an elevator car 12A-B operably coupled to an elevator controller 14. The elevator car 12A-B includes a door operating device 16A-B operably coupled thereto and in communication with the elevator controller 14A-B, wherein the door operating device 16A-B is configure to open and close the elevator doors 18A-B, 20 (i.e., hoistway and car doors).

The elevator system 10 further includes a mobile call input device 22 in communication with the elevator controller 14A-B. In an embodiment the mobile call input device 22 includes a mobile telephone. It will be appreciated that the mobile call input device 22 may be any mobile device specifically suited for this purpose, for example, a tablet device, or any device capable of being carried by a person outside of a home to name a few non-limiting examples.

A communication module (not shown) may be located in the elevator controller 14A-B and the mobile call input device 22 to enable wireless communication between the elevator controller 14 and the mobile call input device 22 via a bus 28. In other embodiments, communication modules (not shown) may be placed throughout a building to form a network to allow the mobile call input device 22 to communicate with the elevator controller 14A-B.

The elevator controller 14 is configured to manage the operation of the elevator car 12A-B. More specifically, for example, the elevator controller 14A-B may include a group management unit 24A-B, respectively connected to one another, and the elevator car 12A-B via the bus 28; thus, when a target floor is registered using the mobile call input device 22, the elevator controller 14A-B is configured to: (a) transmit the floor request data to the group management unit 24A-B, which will assign the most suitable elevator car 12A-B (e.g., the elevator car 12A-B that can be brought to the target floor in the shortest time possible) based on the registered target floor registration information; (b) receive assignment data from the group management unit 24A-B; (c) compute a boarding time in consideration of the existing condition of the assigned elevator car 12A-B as well as anticipated future events; and (d) transmit the boarding time to the user through the mobile call input device 22.

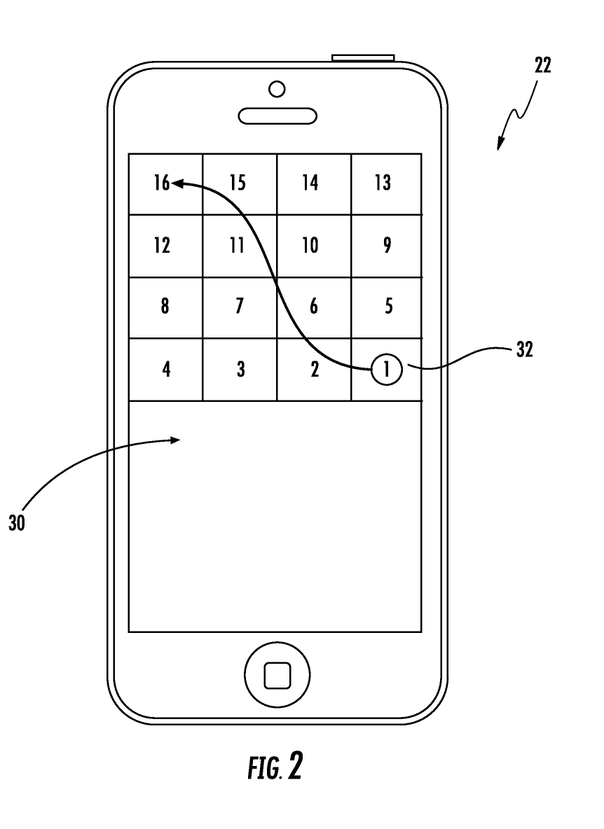

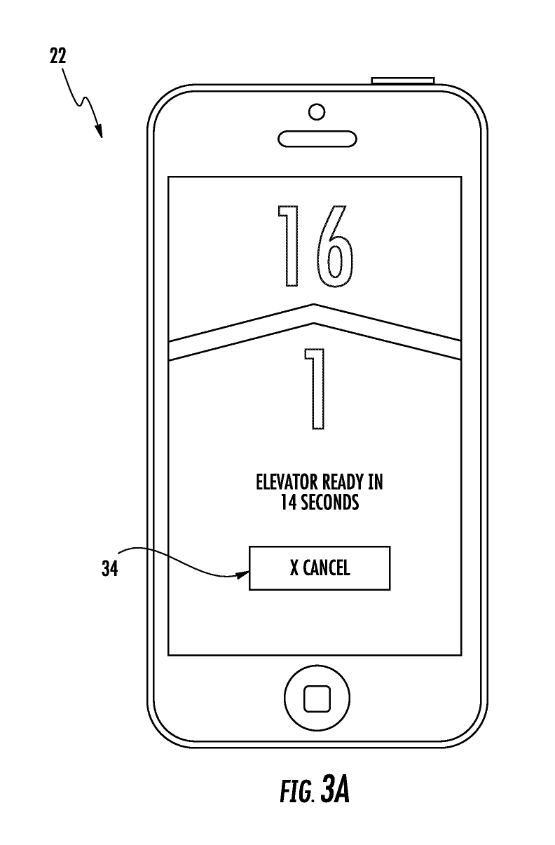

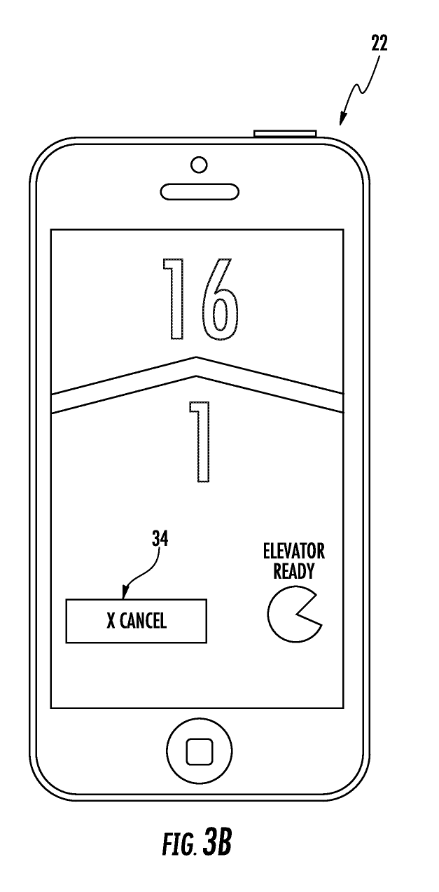

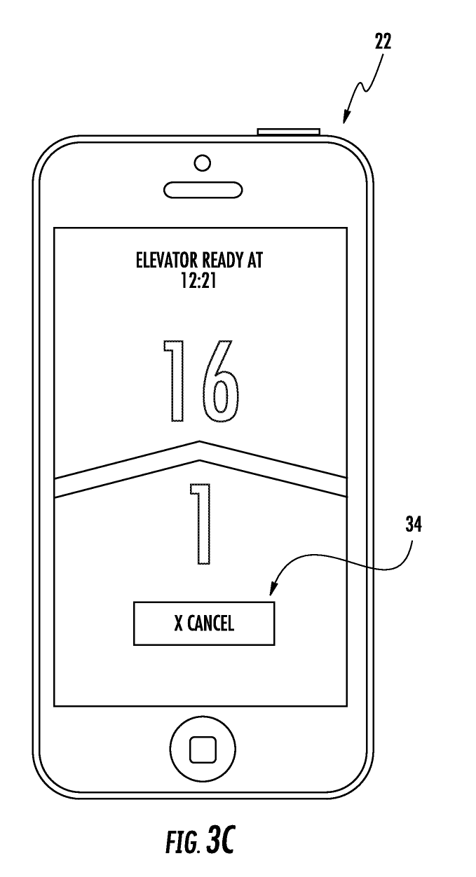

As shown in FIG. 2, the mobile call input device 22 includes a registration operation part 30 for registering a target floor using graphical objects 32 displayed on the mobile call input device 22. As shown in FIGS. 3A-C, the mobile call input device 22 displays pieces of information regarding the target floor and the estimated boarding time computed by the elevator controller 14, wherein the boarding time may be defined as the estimated time the user may enter the elevator car 12A-B (i.e., arrival time of the elevator car 12A-B with the elevator doors 18A-B, 20 in a fully open position). In some embodiments, the user may operate the registration operation part 30 to cancel the requested elevator service by using a cancel button 34 displayed on the mobile call input device 22.

For example, as shown in FIGS. 3A-C, when the user registers the 16th floor as the target floor using the numeric keys, information on the registered target floor is sent to the elevator controller 14A-B. The elevator controller 14: (a) receives the floor request data from the mobile call input device 22; (b) assigns (computes) the most suitable elevator for the user; (c) computes a boarding time for the time it will take for the assigned elevator car 12A-B to arrive at the floor and fully open the elevator doors 18A-B, 20 where the user is present in consideration of then existing condition of the assigned elevator as well as anticipated future events; and (d) transmits the pieces of information on the expected boarding time to the mobile call input device 22 (as shown in FIG. 4). It will be appreciated that the building may have more than one elevator to service the floors, in which case the elevator controller 14 may also transmit information about which elevator car 12A-B is assigned to the target floor.

In response, the target floor “16”, and in some instances the origination floor “1” and the direction of travel are displayed on the mobile call input device 22. Additionally, “Elevator Ready in 14 seconds” (i.e., the boarding time) are displayed on the mobile call input device 22, as shown in FIG. 3B. Due to the displayed boarding time, the user can move to the landing of the assigned elevator car without anxiety because he/she knows he/she has about 14 seconds to reach the assigned elevator car's landing. If the user realizes that he/she will not make it to the elevator before the boarding time, the user may cancel the requested service my using the “Cancel” button 34.

To promote visual understanding of the respective kinds of information displayed on the mobile call input device 22, the estimated boarding time may be presented in the form of a drawing and/or in color instead of (or in addition to) in the form of numbers. In some embodiments, although the estimated boarding time may be represented by numbers in the mobile call input device 22 as shown in FIG. 3A, a drawing of a graphical countdown clock may be displayed as shown in FIG. 3B, and/or the estimated time of boarding may be displayed as shown in FIG. 3C. That is, instead of displaying the amount of time until boarding, the mobile call input device 22 may show the time of day the user may board the elevator car 12A-B. It will be appreciated that the information displaying the estimated boarding time may be placed in any suitable space on the display of the mobile call input device 22.

When control of the elevator car 12A-B is carried out in the aforementioned manner, the user can move to the landing without worrying whether the elevator car 12A-B has already departed. Moreover, as the time required for the assigned elevator car 12A-B to arrive and allow the user to board can be acknowledged at the time of registration of the target floor, any feelings of uneasiness and/or pressure that the user may otherwise experience may be eliminated (or at least reduced). Finally, the user will come to know intuitively how much time he/she has before the user may board the elevator car 12A-B according to the display of the mobile call input device 22, thereby further reducing or eliminating any feelings of uneasiness and/or pressure.

In another embodiment, the elevator controller 14A-B may transmit an elevator arrival signal to the mobile call input device 22. In this embodiment, once the elevator car 12A-B is located at the registered target floor with the elevator doors 18A-B, 20 in a fully open state, the controller 14A-B transmits a signal to alert the user that the elevator car 12A-B is ready for boarding; thus providing another signal to aid the user in determining when the elevator car 12A-B is at the user's desired location.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. An elevator system comprising:
an elevator hoistway, wherein the elevator hoistway comprises a hoistway door;
an elevator car disposed within the elevator hoistway, the elevator car comprising:
an elevator car door; and
a door operating device operably coupled to the elevator car door, wherein the door operating device is configured to move the elevator car door and the hoistway door between a fully open state and a fully closed state;
an elevator controller operably coupled to the elevator car, wherein the elevator controller is configured to:
a) receive registered target floor registration information;
b) assign the elevator car based in part on a registered target floor registration information;
c) compute an estimated boarding time based in part on an existing condition of the assigned elevator car; and
d) transmit the estimated boarding time;
wherein the estimated boarding time comprises the arrival time of the elevator car based on the registered target floor registration information and the duration of time to place the elevator car door and the hoistway door in a fully open state.

2. The elevator system of claim 1, wherein the elevator controller is further configured to transmit an elevator arrival signal.

3. The elevator system of claim 2, wherein the elevator arrival signal comprises a time wherein the assigned elevator car is located at the registered target floor and the elevator car door and the hoistway door are in a fully open state.

4. The elevator system of claim 2, further comprising a mobile call input device in communication with the elevator controller, wherein the mobile call input device comprises a registration operation part to create the registered target floor registration information.

5. The elevator system of claim 4, wherein the mobile call input device further comprises a display.

6. The elevator system of claim 4, wherein the mobile call input device is configured to:
a) allow a user to create the registered target floor registration information by registering a target floor using a graphical object displayed thereon;
b) receive the estimated boarding time from the elevator controller; and
c) display the estimated boarding time.

7. The elevator system of claim 2, wherein the mobile call input device is further configured to display the elevator arrival signal.

8. The elevator system of claim 2, wherein the mobile call input device is in wireless communication with the elevator controller.

9. The elevator system of claim 2, wherein the mobile call input device comprises a mobile telephone.

10. The elevator system of claim 2, further comprising a plurality of communication modules in communication with the elevator controller.

11. A method of determining an estimated elevator boarding time using an elevator system in communication with a mobile call input device, the elevator system includes an elevator car disposed within an elevator hoistway including a hoistway door, the elevator car including an elevator car door and a door operating device operably coupled to the elevator car door, wherein the door operating device is configured to move the elevator car door and hoistway door between a fully open state and a fully closed state, and an elevator controller operably coupled to the elevator car, the method comprising:
a) operating the mobile call input device to generate registered target floor registration information;
b) operating the elevator controller to receive the registered target floor registration information, and assign an elevator car based in part on a registered target floor registration information;
c) operating the elevator controller to determine an estimated boarding time based in part on the existing condition of the assigned elevator car; and
d) operating the elevator controller to transmit the estimated boarding time to the mobile call input device;
wherein the estimated boarding time comprises the arrival time of the elevator car based on the registered target floor registration information and a duration of time to place the elevator car door and the hoistway door in a fully open state.

12. The method of claim 11, further comprising:
(e) operating the elevator controller to transmit an elevator arrival signal.

13. The method of claim 12, wherein the elevator arrival signal comprises a time wherein the assigned elevator car is located at the registered target floor and the elevator car door and the hoistway door are in a fully open state.
